(19) United States
(12) Patent Application Publication
(10) Pub. No.: US 2025/0051575 A1
(43) Pub. Date: Feb. 13, 2025

(54) ROOFING MEMBRANE WITH SUSTAINABLE AND RENEWABLE COMPONENTS

(71) Applicant: The Garland Company, Inc., Independence, OH (US)

(72) Inventors: David Sokol, Vermillion Township, OH (US); Julie Anne Geyer, Independence, OH (US); Matt McDermott, Independence, OH (US)

(21) Appl. No.: 18/793,513

(22) Filed: Aug. 2, 2024

Related U.S. Application Data
(60) Provisional application No. 63/531,731, filed on Aug. 9, 2023.

(51) Int. Cl. C08L 95/00; E04D 5/12

(52) U.S. Cl. CPC C08L 95/00; E04D 5/12; C08L 2205/16; C08L 2555/34; C08L 2555/80

(57) ABSTRACT

A bitumen roofing membrane that includes a bitumen compound layer and a fiber reinforcement layer, and optionally a granular top surface layer. The filler and/or the fiber reinforcement includes 0.5-100 wt. % recycled material.

### REFERENCED APPLICATION

This patent application claims the benefit of U.S. Provisional Patent Application Ser. No. 63/531,731 filed Aug. 9, 2023 and entitled “Roofing Membrane with Sustainable and Renewable Components”, the disclosure of which is hereby incorporated fully by reference herein in its entirety and made part of the present U.S. utility patent application for all purposes.

### FIELD OF DISCLOSURE

The present disclosure is directed to a roofing membrane system that is more environmentally friendly than prior roofing membrane systems; and particularly the present disclosure is directed to a bitumen roofing membrane that is more environmentally friendly; and more particularly the present disclosure is directed to a bitumen roofing membrane that is more environmentally friendly and includes a reinforcement layer; and still more particularly the present disclosure is directed to a bitumen roofing membrane that is more environmentally friendly and includes a reinforcement layer that comprises a fiber reinforcement layer, and which roofing membrane has carbon dioxide absorbing properties.

### BACKGROUND OF THE DISCLOSURE

There is a need for a more environmentally friendly roofing membrane.

Prior art patents that are incorporated herein by reference are U.S. Pat. Nos. 2,379,358; 3,255,031; 3,479,201; 3,528,842; 4,039,706; 4,120.132; 4,288,959; 4,342,804; 4,478,869; 5,088,259; 5,456,785; 5,474,838; 5,540,971; 5,643,399; 5,573,810; 5,695,373; 5,813,176; 5,965,626; 6,110,846; 6,194,519; 6,207,593; 6,296,912; 6,296,921; 6,341,462; 6,360,511; 6,502,360; 7,803,725; 10,626,615; 10,597,555; 11,046,613; 11,433,366; 11,427,507; 11,371,244; and 11,453,614. These references illustrate various types roof membranes and particles applied to the roof membranes.

### SUMMARY OF DISCLOSURE

The present disclosure is directed to an improved roofing membrane system; particularly the present disclosure is directed to a roofing membrane system that is more environmentally friendly than prior roofing membrane systems; and particularly the present disclosure is directed to a bitumen roofing membrane that is more environmentally friendly; and more particularly the present disclosure is directed to a bitumen roofing membrane that is more environmentally friendly and includes a reinforcement layer; and still more particularly the present disclosure is directed to a bitumen roofing membrane that is more environmentally friendly and includes a reinforcement layer that comprises a fiber reinforcement layer, and which roofing membrane has carbon dioxide absorbing properties. In another non-limiting embodiment, the present disclosure is directed to a long-lasting bitumen roofing membrane that includes a blend of recycled and traditionally processed modifiers and sourced additives to create a more eco-friendly and sustainable roofing membrane while retaining the desired properties of a long-lasting roofing membrane such as improved material retention, low temperature flexibility, and UV and oxidation resistance. In another non-limiting embodiment, the present disclosure is directed to a long-lasting bitumen roofing membrane that has a reduced carbon footprint and is a more sustainable product by employing asphalt modifiers from non-traditional sources that do not rely on pollution-creating petrochemical manufacturing processes, but rather from post-industrial and post-consumer recycled and/or renewable sources that eliminate material from landfills. In another non-limiting embodiment, the present disclosure is directed to a long-lasting bitumen roofing membrane that utilizes post-industrial and post-consumer recycled polymer materials to help improve the properties of the bitumen roofing material. In another aspect, the present disclosure uses recycled materials to provide a partial replacement of asphalt, with or without virgin polymers, to improve and strengthen the bitumen material.

In one non-limiting embodiment, the bitumen roofing membrane includes 1) a bitumen compound layer, 2) a fiber reinforcement (e.g., fiber mat, fiber strands, fibers, etc.) and optionally 3) one or more of a) an optional release liner releasably positioned on the bottom surface of the bitumen roofing membrane, b) an optional release film releasably positioned on the top surface of the fiber mat, and/or c) an optionally layer of particles on the top surface of the bitumen roofing membrane.

### The Bitumen Compound Layer

The bitumen compound layer includes a primary hydrocarbon compound (e.g., bitumen or asphalt, coal tar); and optionally one or more of a) filler (e.g., calcium carbonate, chalk, clay, dolomite, kaolin, silica, talc, etc.); b) polymer modifier (e.g., APAO [amorphous polyolefin], APP [atactic polypropylene], EVA [ethylene vinyl acetate], EBA [ethylene butyl acrylate], PPA [polyphthalamide], PPI [polymeric polyisocyanate], PE [polyethylene], PP [polypropylene] SEBS [styrene ethylene butadiene styrene], SBS [styrene butadiene styrene], SIS [styrene-isoprene-styrene], thermoplastic urethane [TPU], etc.); c) hydrocarbon resin or process oil (e.g., naphthenic oil, paraffinic oil, C5-C9 aromatic hydrocarbon, etc.); d) ground tire rubber; e) tackifying agent; f) antioxidant; g) UV stabilizer; h) cross-linkers; i) biocide; j) coloring agent; k) metal flakes; l) adhesion enhancer; m) fire retardant (e.g., alumina trihydrate, ammonium polyphosphate, etc.); n) softening agent; o) wax (e.g., paraffin wax, etc.); p) acid (e.g., stearic acid, etc.); and/or q) reinforcement fibers (e.g., Kevlar®, carbon fibers, fiberglass, boron fibers, polyethylene fibers, polypropylene fibers, recycled polymer and/or plastic fibers, etc.).

In one non-limiting embodiment, the primary hydrocarbon compound constitutes 25-90 wt. % (and all values and ranges therebetween) of the bitumen compound layer. In one specific formulation, the primary hydrocarbon compound constitutes 25-80 wt. % of the bitumen compound layer. In another specific formulation, the primary hydrocarbon compound constitutes 25-60 wt. % of the bitumen compound layer. In another specific formulation, the primary hydrocarbon compound constitutes 25-50 wt. % of the bitumen compound layer. In another specific formulation, the primary hydrocarbon compound constitutes 25-49 wt. % of the bitumen compound layer. The primary hydrocarbon compound can be fully formed of bitumen, or can be a mixture of bitumen and coal tar. The type of bitumen used in the bitumen compound layer is non-limiting. In one non-limiting example, the bitumen is PG64-22 grade. In another non-limiting example, the bitumen is bitumen penetration grade 40/50. In another non-limiting example, the bitumen is bitumen penetration grade 50/70. In another non-limiting example, the bitumen is bitumen penetration grade 60/70. In another non-limiting example, the bitumen or blend of bitumen (when used) has a softening point about 43.3-121.1° C. (110-250° F.) (and all values and ranges therebetween); and a penetration typically of about 4-80 dmm (and all values and ranges therebetween) at 22.2° C. (75° F.). In one non-limiting embodiment, the primary hydrocarbon compound includes 25-100 wt. % bitumen (and all values and ranges therebetween) and 0-75 wt. % coal tar (and all values and ranges therebetween). In another non-limiting embodiment, the primary hydrocarbon compound includes 60-100 wt. % bitumen and 0-40 wt. % coal tar (and all values and ranges therebetween). In another non-limiting embodiment, the primary hydrocarbon compound includes 25-90 wt. % bitumen and 10-75 wt. % coal tar.

The filler, when included in the bitumen compound layer, constitutes about 0.5-66 wt. % (and all values and ranges therebetween) of the bitumen compound layer. In one non-limiting formulation, the filler (when used) constitutes 0.5-60 wt. % of the bitumen compound layer. In another non-limiting formulation, the filler (when used) constitutes 5-50 wt. % of the bitumen compound layer. In another non-limiting formulation, the filler (when used) constitutes 10-50 wt. % of the bitumen compound layer. In another non-limiting formulation, the filler (when used) constitutes 10-35 wt. % of the bitumen compound layer. In another non-limiting formulation, the filler (when used) constitutes 12-35 wt. % of the bitumen compound layer. In another non-limiting formulation, the weight percent of filler in the bitumen compound layer (when used) is less than the weight percent of the primary hydrocarbon compound in the bitumen compound layer. The filler can include one or more of calcium carbonate (e.g., oyster shells and other shells of marine organisms, snail shells, coal balls, pearls, eggshells, chalk, limestone, etc.), clay (e.g., recycled tile, recycled clay plates, recycled porcelain, recycled dishes, recycled pots, etc.), dolomite, kaolin (e.g., recycled porcelain, recycled china, feldspar, etc.), silica, talc, etc.; however, other or additional filler can be used. In one non-limiting formulation, the filler (when used) includes calcium carbonate, silica, and/or talc. In another non-limiting formulation, the filler (when used) includes calcium carbonate. In another non-limiting formulation, the filler (when use), includes calcium carbonate, and 5-100% (and all values and ranges therebetween) of the calcium carbonate comes from a recycled and/or non-mined source (e.g., oyster shells and other shells of marine organisms, snail shells, coal balls, pearls, eggshells, etc.). In another non-limiting formulation, the filler (when used) includes calcium carbonate and one or more other filler, and wherein the 5-100% of the calcium carbonate comes from a recycled and/or non-mined source, and wherein 5-100% (and all values and ranges therebetween) of the one or more other fillers comes from a recycled and/or non-mined source.

The polymer modifier, when included in the bitumen compound layer, constitutes about 0.05-30 wt. % (and all values and ranges therebetween) of the bitumen compound layer. In one non-limiting formulation, the polymer modifier (when used) constitutes 0.1-25 wt. % of the bitumen compound layer. In another non-limiting formulation, the polymer modifier (when used) constitutes 2-20 wt. % of the bitumen compound layer. In another non-limiting formulation, the weight percent of polymer modifier in the bitumen compound layer (when used) is less than the weight percent of the primary hydrocarbon compound in the bitumen compound layer. The polymer modifier can include one or more of APAO (amorphous polyolefin), APP (atactic polypropylene), EVA (ethylene vinyl acetate), EBA (ethylene butyl acrylate), PPA (polyphthalamide), PPI (polymeric polyisocyanate), PE (polyethylene), PP (polypropylene), SEBS (styrene ethylene butadiene styrene), SBS (styrene butadiene styrene), SIS (styrene-isoprene-styrene), SBR (styrene-butadiene-rubber), thermoplastic urethane (TPU), etc.; however, other or additional polymer modifier can be used. In one non-limiting formulation, the polymer modifier includes SBS and/or polyurethane. In another non-limiting formulation, the polymer modifier includes SBS. In another non-limiting formulation, the polymer modifier includes 0.5-100% (and all values and ranges therebetween) recycled polymer material. In another non-limiting formulation, the polymer modifier includes 60-100% recycled polymer material. Non-limiting recycled plastics and/or polymer include recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycled synthesized plastics, etc.

The process oil or hydrocarbon resin, when included in the bitumen compound layer, is about 0.05-30 wt. % (and all values and ranges therebetween) of the bitumen compound layer. In one non-limiting formulation, the process oil or hydrocarbon resin (when used) constitutes 0.05-20 wt. % of the bitumen compound layer. In another non-limiting formulation, the process oil or hydrocarbon resin (when used) constitutes 0.1-10 wt. % of the bitumen compound layer. In another non-limiting formulation, the process oil or hydrocarbon resin (when used) constitutes 0.1-3 wt. % of the bitumen compound layer. In another non-limiting formulation, the weight percent of process oil or hydrocarbon resin in the bitumen compound layer (when used) is less than the weight percent of the primary hydrocarbon compound in the bitumen compound layer. The hydrocarbon resin or process oil can include one or more of naphthenic oil, paraffinic oil, C5-C9 aromatic hydrocarbon, etc. In one non-limiting formulation, the hydrocarbon resin or process oil includes naphthenic oil and/or paraffinic oil; however, other or additional hydrocarbon resin or process oil can be used.

The ground tire rubber, when included in the bitumen compound layer, is about 0.5-25 wt. % (and all values and ranges therebetween) of the bitumen compound layer. In one non-limiting formulation, the ground tire rubber (when used) constitutes 0.5-10 wt. % of the bitumen compound layer. In another non-limiting formulation, the ground tire rubber (when used) constitutes 0.8-8 wt. % of the bitumen compound layer. In another non-limiting formulation, the ground tire rubber (when used) constitutes 1-5 wt. % of the bitumen compound layer. In another non-limiting formulation, the weight percent of ground tire rubber in the bitumen compound layer (when used) is less than the weight percent of the primary hydrocarbon compound in the bitumen compound layer. The size of the ground tire rubber has been found to be important. Particles of ground tire rubber that are too large can adversely affect flexibility and other properties of the bitumen compound layer. It has been found that the average particle size of the ground tire rubber that no greater than 100 mesh (149 microns) imparts the desired properties to the bitumen compound layer. In one non-limiting embodiment, the average particle size of the ground tire rubber is 100 mesh (149 microns) to 400 mesh (37 microns) (and all values and ranges therebetween). In another non-limiting embodiment, the average particle size of the ground tire rubber is 100 mesh (149 microns) to 200 mesh (74 microns). In another non-limiting embodiment, the average particle size of the ground tire rubber is 120 mesh (125 microns) to 170 mesh (88 microns). In another non-limiting embodiment, the tire rubber includes one or more of butadiene rubber and styrene butadiene rubber, and optionally natural rubber.

The antioxidant, when included in the bitumen compound layer, is about 0.01-30 wt. % (and all values and ranges therebetween) of the bitumen compound layer. In one non-limiting formulation, the antioxidant (when used) constitutes 0.02-5 wt. % of the bitumen compound layer. In another non-limiting formulation, the antioxidant (when used) constitutes 0.05-1 wt. % of the bitumen compound layer. In another non-limiting formulation, the weight percent of antioxidant in the bitumen compound layer (when used) is less than the weight percent of the primary hydrocarbon compound in the bitumen compound layer. The antioxidant can include one or more of aromatic amines, hindered phenolics, phosphites, sulfur-containing compounds (e.g., thioethers, thioesters, etc.); however, other or additional antioxidant can be used.

The UV stabilizer, when included in the bitumen compound layer, is about 0.01-30 wt. % (and all values and ranges therebetween) of the bitumen compound layer, and typically constitutes 0.02-5 wt. % of the bitumen compound layer. In another non-limiting formulation, the UV stabilizer (when used) constitutes 0.05-1 wt. % of the bitumen compound layer. In another non-limiting formulation, the weight percent of UV stabilizer in the bitumen compound layer (when used) is less than the weight percent of the primary hydrocarbon compound in the bitumen compound layer. The UV stabilizer can include one or more of benzotriazole UV absorber, hindered amine radical scavenge (e.g., Light Stabilizer 770 [Bis (2,2,6,6-tetramethyl-4-piperidine) sebacate], etc.), hindered amine light stabilizer (HALS) (e.g., derivatives of tetramethylpiperidine, etc.), layered double hydroxide (LDH), carbon black, etc.; however, other or additional UV stabilizer can be used.

The cross-linkers, when included in the bitumen compound layer, are about 0.05-30 wt. % (and all values and ranges therebetween) of the bitumen compound layer. In one non-limiting formulation, the cross-linkers (when used) constitute 0.05-10 wt. % of the bitumen compound layer. In another non-limiting formulation, the cross-linkers (when used) constitute 0.05-5 wt. % of the bitumen compound layer. In another non-limiting formulation, the weight percent of cross-linkers in the bitumen compound layer (when used) is less than the weight percent of the primary hydrocarbon compound in the bitumen compound layer. The cross-linkers can include one or more of sulfur, sulfur compounds, bismaleimides, polymerizable monofunctional vinyl aromatic monomer (e.g., styrene, etc.), polyfunctional polymerizable vinyl aromatic monomer (e.g., divinylbenzene etc.), etc.; however, other or additional cross-linkers can be used.

The biocide, when included in the bitumen compound layer, is about 0.05-30 wt. % (and all values and ranges therebetween) of the bitumen compound layer. In one non-limiting formulation, the biocide (when used) constitutes 0.05-5 wt. % of the bitumen compound layer. In another non-limiting formulation, the biocide (when used) constitutes 0.05-1 wt. % of the bitumen compound layer. In another non-limiting formulation, the weight percent of biocide in the bitumen compound layer (when used) is less than the weight percent of the primary hydrocarbon compound in the bitumen compound layer. The biocide can include one or more of copper sulfate, zinc chloride, quaternary ammonium-based biocides, aldehydes, hydroxy compounds, 0-phthalaldehyde, etc.; however, other or additional biocide can be used.

The coloring agent, when included in the bitumen compound layer, is about 0.05-30 wt. % (and all values and ranges therebetween) of the bitumen compound layer. In one non-limiting formulation, the coloring agent (when used) constitutes 0.05-5 wt. % of the bitumen compound layer. In another non-limiting formulation, the coloring agent (when used) constitutes 0.05-4 wt. % of the bitumen compound layer. In another non-limiting formulation, the weight percent of coloring agent in the bitumen compound layer (when used) is less than the weight percent of the primary hydrocarbon compound in the bitumen compound layer.

The metal flakes, when included in the bitumen compound layer, are about 0.05-30 wt. % (and all values and ranges therebetween) of the bitumen compound layer. In one non-limiting formulation, the metal flakes (when used) constitute 0.05-5 wt. % of the bitumen compound layer. In another non-limiting formulation, the metal flakes (when used) constitute 0.05-2 wt. % of the bitumen compound layer. In another non-limiting formulation, the weight percent of metal flakes in the bitumen compound layer (when used) is less than the weight percent of the primary hydrocarbon compound in the bitumen compound layer.

The adhesion enhancer, when included in the bitumen compound layer, is about 0.05-30 wt. % (and all values and ranges therebetween) of the bitumen compound layer. In one non-limiting formulation, the adhesion enhancer (when used) constitutes 0.05-5 wt. % of the bitumen compound layer. In another non-limiting formulation, the adhesion enhancer (when used) constitutes 0.05-2 wt. % of the bitumen compound layer. In another non-limiting formulation, the weight percent of adhesion enhancer (when used) in the bitumen compound layer is less than the weight percent of the primary hydrocarbon compound in the bitumen compound layer. The adhesion enhancer can include one or more of amine adhesion promoters, naphthenates, organosilanes-based adhesion promoters, etc.; however, other or additional adhesion enhancer can be used.

The fire retardant, when included in the bitumen compound layer, is about 0.05-30 wt. % (and all values and ranges therebetween) of the bitumen compound layer. In one non-limiting formulation, the fire retardant (when used) constitutes 0.05-25 wt. % of the bitumen compound layer. In another non-limiting formulation, the fire retardant (when used) constitutes 0.05-20 wt. % of the bitumen compound layer. In another non-limiting formulation, the fire retardant (when used) constitutes 0.05-15 wt. % of the bitumen compound layer. In another non-limiting formulation, the weight percent of fire retardant in the bitumen compound layer (when used) is less than the weight percent of the primary hydrocarbon compound in the bitumen compound layer. The fire retardant can include one or more of alumina trihydrate, ammonium polyphosphate, magnesium hydroxide, antimony trioxide, melamine, etc.; however, other or additional fire retardant can be used. In another non-limiting embodiment, the fire retardant can include alumina trihydrate and ammonium polyphosphate. In another non-limiting embodiment, the fire retardant can include alumina trihydrate and ammonium polyphosphate, and the weight ratio of alumina trihydrate to ammonium polyphosphate is 1.1:1 to 45:1 (and all values and ranges therebetween).

The tackifying agent, when included in the bitumen compound layer, is about 0.05-30 wt. % (and all values and ranges therebetween) of the bitumen compound layer. In one non-limiting formulation, the tackifying agent (when used) constitutes 0.05-5 wt. % of the bitumen compound layer. In another non-limiting formulation, the tackifying agent (when used) constitutes 0.05-2 wt. % of the bitumen compound layer. In another non-limiting formulation, the weight percent of tackifying agent (when used) in the bitumen compound layer is less than the weight percent of the primary hydrocarbon compound in the bitumen compound layer. The tackifying agent can include one or more of inorganic salt electrolytes and organic tackifiers, etc.; however, other or additional tackifying agent can be used.

The softening agent, when included in the bitumen compound layer, is about 0.05-30 wt. % (and all values and ranges therebetween) of the bitumen compound layer. In one non-limiting formulation, the softening agent (when used) constitutes 0.05-5 wt. % of the bitumen compound layer. In another non-limiting formulation, the softening agent (when used) constitutes 0.05-2 wt. % of the bitumen compound layer. In another non-limiting formulation, the weight percent of softening agent (when used) in the bitumen compound layer is less than the weight percent of the primary hydrocarbon compound in the bitumen compound layer.

The wax, when included in the bitumen compound layer, is about 0.05-15 wt. % (and all values and ranges therebetween) of the bitumen compound layer. In one non-limiting formulation, the wax (when used) constitutes 0.05-5 wt. % of the bitumen compound layer. In another non-limiting formulation, the wax (when used) constitutes 0.1-3 wt. % of the bitumen compound layer. In another non-limiting formulation, the weight percent of wax (when used) in the bitumen compound layer is less than the weight percent of the primary hydrocarbon compound in the bitumen compound layer. The wax can include paraffin wax, polypropylene wax, Fischer-Tropsic wax, ester wax, amide wax, THP wax, microcrystalline wax, etc.; however, other or additional waxes can be used.

The acid, when included in the bitumen compound layer, is about 0.05-15 wt. % (and all values and ranges therebetween) of the bitumen compound layer. In one non-limiting formulation, the acid (when used) constitutes 0.05-5 wt. % of the bitumen compound layer. In another non-limiting formulation, the acid (when used) constitutes 0.05-1 wt. % of the bitumen compound layer. In another non-limiting formulation, the weight percent of acid (when used) in the bitumen compound layer is less than the weight percent of the primary hydrocarbon compound in the bitumen compound layer. The acid can include stearic acid, etc.; however, other or additional acid can be used.

The reinforcement fibers, when included in the bitumen compound layer, are about 0.05-40 wt. % (and all values and ranges therebetween) of the bitumen compound layer. In one non-limiting formulation, the reinforcement fibers (when used) constitute 0.05-30 wt. % of the bitumen compound layer. In another non-limiting formulation, the reinforcement fibers (when used) constitute 0.05-25 wt. % of the bitumen compound layer. In another non-limiting formulation, the weight percent of reinforcement fibers (when used) in the bitumen compound layer is less than the weight percent of the primary hydrocarbon compound in the bitumen compound layer. Generally, the reinforcement fibers are dispersed in the bitumen compound layer and do not form a layer in the bitumen compound layer or the bitumen roofing membrane. In one non-limiting arrangement, the reinforcement fibers are uniformly dispersed in the bitumen compound layer and do not form a layer in the bitumen compound layer; however, this is not required.

The reinforcement fibers can include one or more of aramid fibers (e.g., poly-para-phenylene terephthalamide [Kevlar®]), carbon fibers, fiberglass, boron fibers, polyethylene fibers, polypropylene fibers, recycled polymer, and/or plastic fibers. In another non-limiting formulation, the reinforcement fibers are formed of 0.5-100% (and all values and ranges therebetween) recycled polymer material. In another non-limiting formulation, the reinforcement fibers are formed of 60-100% recycled polymer material. Non-limiting recycled plastics and/or polymers include recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycled synthesized plastics, etc. In one non-limiting embodiment, the length of the reinforcement fibers (when used) have an average length of 1 micron to 30 mm (and all values and ranges therebetween).

In one non-limiting embodiment, the weight percent of the primary hydrocarbon compound in the bitumen compound layer is greater than the combined weight percent of filler, polymer modifier, hydrocarbon resin or process oil, tackifying agent, antioxidant, UV stabilizer, cross-linkers, biocide, coloring agent, metal flakes, adhesion enhancer, fire retardant, softening agent, wax, acid, ground tire rubber, and reinforcement fibers in the bitumen compound layer

In another non-limiting embodiment, the weight percent of the primary hydrocarbon compound in the bitumen compound layer is greater than the combined weight percent of polymer modifier, hydrocarbon resin or process oil, tackifying agent, antioxidant, UV stabilizer, cross-linkers, biocide, coloring agent, metal flakes, adhesion enhancer, fire retardant, softening agent, wax, acid, ground tire rubber, and reinforcement fibers in the bitumen compound layer.

In another non-limiting embodiment, the weight percent of the primary hydrocarbon compound in the bitumen compound layer is greater than the combined weight percent of polymer modifier, hydrocarbon resin or process oil, tackifying agent, antioxidant, UV stabilizer, cross-linkers, biocide, coloring agent, adhesion enhancer, fire retardant, softening agent, wax, ground tire rubber, and acid in the bitumen compound layer.

In another non-limiting embodiment, the bitumen compound layer is partially or fully formed of a rubber-bitumen-containing ground tire rubber and one or more of SBS, SEBS, SIS, or other rubber polymers known in the art. The bitumen compound layer can optionally contain fire retardants, and/or tackifier resins. The bitumen compound layer can optionally be reinforced to add internal strength to the bitumen compound layer.

In another non-limiting embodiment, the thickness of the entire bitumen compound layer is generally 10-250 mil (0.01-0.25 in.) (and all values and ranges therebetween). In one non-limiting arrangement, the thickness of the entire bitumen compound layer is generally 20-150 mil. In another non-limiting arrangement, the thickness of the entire bitumen compound layer is generally 40-130 mil. In another non-limiting arrangement, the thickness of the entire bitumen compound layer is generally 80-100 mil.

In another non-limiting embodiment, the bitumen compound layer forms a waterproofing layer on the bitumen roofing membrane.

Non-limiting examples of the composition of the bitumen compound layer (absent any optional fiber reinforcement layer) are as follows:

### EXAMPLE 1

| | | |
|---|---|---|
| Primary hydrocarbon compound | 25-90 | wt. % |
| Filler | 0-66 | wt. % |
| Polymer Modifier | 0-30 | wt. % |
| Hydrocarbon Resin Process Oil | 0-30 | wt. % |
| Ground Tire Rubber (no greater than | 0.5-25 | wt. % |
| 100 mesh (149 microns) average size) | | |
| Antioxidant | 0-30 | wt. % |
| UV Stabilizer | 0-30 | wt. % |
| Cross-Linker | 0-30 | wt. % |
| Biocide | 0-30 | wt. % |
| Coloring Agent | 0-30 | wt. % |
| Metal Flakes | 0-30 | wt. % |
| Adhesion Enhancer | 0-30 | wt. % |
| Fire Retardant | 0-30 | wt. % |
| Tackifying Agent | 0-30 | wt. % |
| Softening Agent | 0-30 | wt. % |
| Wax | 0-15 | wt. % |
| Acid | 0-15 | wt. % |
| Fiber reinforcement | 0-40 | wt. % |

and wherein the polymer modifier, filler, and/or the fiber reinforcement includes 0-100 wt. % (and all values and ranges therebetween) recycled material.

### EXAMPLE 2

| | | |
|---|---|---|
| Primary hydrocarbon compound | 25-80 | wt. % |
| Filler (e.g., calcium carbonate, silica, talc, etc.) | 0.5-60 | wt. % |
| Polymer Modifier (e.g., SBS, polyurethane, etc.) | 0.05-25 | wt. % |
| Ground Tire Rubber (no greater than | 0.5-20 | wt. % |
| 100 mesh (149 microns) average size) | | |
| Hydrocarbon Resin Process Oil (e.g., naphthenic | 0-20 | wt. % |
| oil, paraffinic oil, etc.) | | |
| Antioxidant | 0-5 | wt. % |
| UV Stabilizer | 0-5 | wt. % |
| Cross-Linker | 0-10 | wt. % |
| Biocide | 0-5 | wt. % |
| Coloring Agent | 0-5 | wt. % |
| Metal Flakes | 0-5 | wt. % |
| Adhesion Enhancer | 0-5 | wt. % |
| Fire Retardant | 0-25 | wt. % |
| Tackifying Agent | 0-5 | wt. % |
| Softening Agent | 0-5 | wt. % |
| Wax | 0-5 | wt. % |
| Acid | 0-5 | wt. % |
| Fiber reinforcement (e.g., fiber, etc.) | 0-30 | wt. % |

and wherein the polymer modifier, filler, and/or the fiber reinforcement includes 0-100 wt. % (and all values and ranges therebetween) recycled material.

### EXAMPLE 3

| | | |
|---|---|---|
| Primary hydrocarbon compound | 25-60 | wt. % |
| Filler (e.g., calcium carbonate, silica, talc, etc.) | 0.5-50 | wt. % |
| Polymer Modifier (e.g., SBS, polyurethane, etc.) | 0.05-20 | wt. % |
| Ground Tire Rubber | 0.5-15 | wt. % |
| 100-200 mesh (149-74 microns) average size) | | |
| Hydrocarbon Resin Process Oil (e.g., naphthenic | 0-15 | wt. % |
| oil, paraffinic oil, etc.) | | |
| Antioxidant | 0-2 | wt. % |
| UV Stabilizer | 0-2 | wt. % |
| Cross-Linker | 0-5 | wt. % |
| Biocide | 0-2 | wt. % |
| Coloring Agent | 0-2 | wt. % |
| Metal Flakes | 0-2 | wt. % |
| Adhesion Enhancer | 0-2 | wt. % |
| Fire Retardant | 0-20 | wt. % |
| Tackifying Agent | 0-2 | wt. % |
| Softening Agent | 0-2 | wt. % |
| Wax | 0-2 | wt. % |
| Acid | 0-2 | wt. % |
| Fiber reinforcement (e.g., fiber, etc.) | 0-25 | wt. % |

and wherein the polymer modifier, filler, and/or the fiber reinforcement includes 5-100 wt. % (and all values and ranges therebetween) recycled material.

### EXAMPLE 4

| | | |
|---|---|---|
| Primary hydrocarbon compound | 25-55 | wt. % |
| Filler (e.g., calcium carbonate, silica, talc, etc.) | 0.05-45 | wt. % |
| Polymer Modifier (e.g., SBS, polyurethane, etc.) | 0.05-10 | wt. % |
| Ground Tire Rubber | 1-12 | wt. % |
| 100-200 mesh (149-74 microns) average size) | | |
| Hydrocarbon Resin Process Oil (e.g., naphthenic | 0-5 | wt. % |
| oil, paraffinic oil, etc.) | | |
| Antioxidant | 0-2 | wt. % |
| UV Stabilizer | 0-2 | wt. % |
| Cross-Linker | 0-5 | wt. % |
| Biocide | 0-1 | wt. % |
| Coloring Agent | 0-2 | wt. % |
| Metal Flakes | 0-2 | wt. % |
| Adhesion Enhancer | 0-2 | wt. % |
| Fire Retardant | 0-20 | wt. % |
| Tackifying Agent | 0-2 | wt. % |
| Softening Agent | 0-2 | wt. % |
| Wax | 0-4 | wt. % |
| Acid | 0-2 | wt. % |
| Fiber reinforcement (e.g., fiber, etc.) | 0-20 | wt. % |

and wherein the polymer modifier, filler, and/or the fiber reinforcement includes 10-100 wt. % (and all values and ranges therebetween) recycled material.

### EXAMPLE 5

| | | |
|---|---|---|
| Primary hydrocarbon compound | 40-80 | wt. |
| (e.g., 80-100 wt. % bitumen) | | |
| Filler (e.g., calcium carbonate, silica, talc, etc.) | 0-60 | wt. % |
| Polymer Modifier (e.g., SBS, polyurethane, etc.) | 1-25 | wt. % |
| Ground Tire Rubber | 0.5-15 | wt. % |
| 100-200 mesh (149-74 microns) average size) | | |
| Hydrocarbon Resin or Process Oil | 0-15 | wt. % |
| (e.g., naphthenic oil, paraffinic oil, etc.) | | |
| Antioxidant | 0-1 | wt. % |
| UV Stabilizer | 0-1 | wt. % |
| Biocide | 0-1 | wt. % |
| Wax | 0-4 | wt. % |
| Fire Retardant | 0-18 | wt. % |
| Fiber reinforcement (e.g., fiber, etc.) | 0-15 | wt. % |

and wherein the polymer modifier, filler, and/or the fiber reinforcement includes 20-100 wt. % (and all values and ranges therebetween) recycled material.

### EXAMPLE 6

| | | |
|---|---|---|
| Primary hydrocarbon compound | 25-65 | wt. % |
| (e.g., 80-100 wt. % bitumen) | | |
| Filler (e.g., calcium carbonate, silica, talc, etc.) | 5-40 | wt. % |
| Polymer Modifier (e.g., SBS, polyurethane, etc.) | 2-20 | wt. % |
| Hydrocarbon Resin or Process Oil | 0-15 | wt. % |
| (e.g., naphthenic oil, paraffinic oil, etc.) | | |
| Antioxidant | 0-1 | wt. % |
| UV Stabilizer | 0-1 | wt. % |
| Biocide | 0-1 | wt. % |
| Wax | 0-3 | wt. % |
| Fire Retardant (e.g., alumina trihydrate, | 0-15 | wt. % |
| ammonium polyphosphate, etc.) | | |
| Fiber reinforcement (e.g., fiber, etc.) | 0-15 | wt. % |

and wherein the polymer modifier, filler, and/or the fiber reinforcement includes 20-100 wt. % (and all values and ranges therebetween) recycled material.

### EXAMPLE 7

| | | |
|---|---|---|
| Primary hydrocarbon compound | 40-60 | wt. % |
| (e.g., 80-100 wt. % bitumen) | | |
| Filler (e.g., calcium carbonate, silica, talc, etc.) | 5-25 | wt. % |
| Polymer Modifier (e.g., SBS, polyurethane, etc.) | 8-20 | wt. % |
| Hydrocarbon Resin or Process Oil | 0-10 | wt. % |
| (e.g., naphthenic oil, paraffinic oil, etc.) | | |
| Antioxidant | 0-1 | wt. % |
| UV Stabilizer | 0-1 | wt. % |
| Biocide | 0-1 | wt. % |
| Wax | 0-3 | wt. % |
| Fire Retardant (e.g., alumina trihydrate, | 1-15 | wt. % |
| ammonium polyphosphate, etc.) | | |
| Fiber reinforcement (e.g., fiber, etc.) | 0-10 | wt. % |

and wherein the polymer modifier, filler, and/or the fiber reinforcement includes 30-100 wt. % (and all values and ranges therebetween) recycled material.

In Examples 1-7, it will be appreciated that all of the above ranges include any value between the range and any other range that is between the ranges set forth above.

### The Fiber Reinforcement Layer

One or more fiber reinforcement layers can optionally be used as a reinforcement for the bitumen roofing membrane. The one or more fiber reinforcement layers (when used) can be a) applied on or above the top surface of the bitumen compound layer, b) applied on or below the bottom surface of the bitumen compound layer, or c) be impregnated or otherwise positioned within the bitumen compound layer. As can be appreciated, multiple fiber reinforcement layers can be used. The one or more fiber reinforcement layers (when used) are different from the fiber reinforcement (when used) in the bitumen compound layer in that the one or more fiber reinforcement layers form a layer of material in the bitumen compound layer and/or the bitumen roofing membrane, whereas the fiber reinforcement (when used) in the bitumen compound layer are dispersed in the bitumen compound layer and do not form a layer in the bitumen compound layer. As can be appreciated, the materials used to form the fiber reinforcement (when used), in the bitumen compound layer and the materials used to form the one or more fiber reinforcement layers can be the same or different.

In one non-limiting embodiment, the fiber reinforcement layer can be in the form of woven mat, non-woven mat, woven and nonwoven mat, sheet, one or more rovings, one or more rows of rovings, etc.

In another non-limiting embodiment, the fiber reinforcement layer can be formed of one or more of fiberglass, nylon, polyester, cotton, silk, wool, hemp, straw, bamboo, flax, jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, aromatic polyamide or aramid fibers (e.g., Kevlar™, Twaron™, etc.), polyethylene fibers, polypropylene fibers, recycled polymer fibers, recycled, plastic fibers, and any blend of these materials. In one non-limiting embodiment, 0.5-100 wt. % (and all values and ranges therebetween) of the fiber reinforcement layer is formed of a recycled polymer material (e.g., recycled polyethylene bottles and/or containers, recycled polypropylene bottles and/or containers, etc.; recycled plastic or polymer components from vehicles [e.g., plastic window and windshield trim, etc.]; recycled plastic or polymers from other sources [e.g., plastic agricultural products, consumer bags, plastic from recycled consumer products and appliances, recycles vinyl siding, recycles plastic panels, recycled industrial equipment, etc.]; recycled polyolefin plastics; recycled synthesized plastics; etc.). In one non-limiting configuration, 60-100 wt. % of the fiber reinforcement layer is formed of a recycled polymer material.

In another non-limiting embodiment, the one or more reinforcement layers can be partially or fully saturated/encapsulated with the bitumen compound layer; however, this is not required.

In another non-limiting embodiment, the one or more reinforcement layers can be secured to the bitumen compound layer by a variety of arrangements (e.g., being partial or fully impregnated in the bitumen compound layer, adhesive, melted connection, stitching, staples, rivets, clamp, etc.).

In another non-limiting embodiment, the one or more reinforcement layers are generally flexible to enable the bitumen compound layer to be rolled into a roll of bitumen compound layer which would otherwise cause damage to the bitumen compound layer. In one non-limiting configuration, the fiber reinforcement layer can be rolled into a roll having a diameter of eight in. or less without damaging the fiber reinforcement layer.

In another non-limiting embodiment, when the fiber reinforcement layer is impregnated in the bitumen compound layer, the fiber reinforcement layer can optionally be located at or near the mid-thickness of the bitumen compound layer; however, this is not required.

In another non-limiting embodiment, the one or more reinforcement layers provide reinforcement and internal strength to the bitumen compound layer.

In another non-limiting embodiment, the fiber reinforcement layer generally extends 1-100% (and all values and ranges therebetween) of the width of the bitumen compound layer, and 1-100% (and all values and ranges therebetween) of the length of the bitumen compound layer. In one non-limiting configuration, the fiber reinforcement layer extends 90-100% of the width of the bitumen compound layer, and 90-100% of the length of the bitumen compound layer.

In another non-limiting embodiment, the thickness of each of the fiber reinforcement layers is generally at least 1 mil (e.g., 1-200 mil [(0.001-0.2 in.] and all values and ranges therebetween). In one non-limiting arrangement, the thickness of each of the fiber reinforcement layers is 2-150 mil. In another non-limiting arrangement, the thickness ratio of the bitumen compound layer to the fiber reinforcement layer is 1.1:1 to 35:1 (and all values and ranges therebetween). In another non-limiting arrangement, the thickness ratio of the bitumen compound layer to the fiber reinforcement layer is 2:1 to 26:1. In another non-limiting arrangement, the thickness ratio of the bitumen compound layer to the fiber reinforcement layer is 4:1 to 20:1.

In another non-limiting embodiment, when the bitumen compound layer includes two or more fiber reinforcement layers, the fiber reinforcement layers are generally spaced from one another; however, this is not required.

In another non-limiting embodiment, when the bitumen compound layer includes two or more fiber reinforcement layers, the thickness of each of the fiber reinforcement layers can be the same or different.

In another non-limiting embodiment, when the bitumen compound layer includes two or more fiber reinforcement layers, the composition of each of the fiber reinforcement layers can be the same or different.

In another non-limiting embodiment, one non-limiting purpose of the one or more fiber reinforcement layers is to act as a reinforcement layer for the bitumen roofing membrane. Another non-limiting optional purpose of the one or more fiber reinforcement layers is to strengthen the bitumen roofing membrane.

In another non-limiting embodiment, when one or more of the fiber reinforcement layers in the form of a fiber mat, the fiber mat generally covers or spans 50-100% (and all values and ranges therebetween) of the width of the bitumen roofing membrane. When the fiber mat overs less than 100% of the width of the bitumen roofing material, the fiber mat can optionally be used to form a lap line region. The width of the lap line region (when used) is generally 0.5-6 in. (and all values and ranges therebetween), typically the width of the lap line region is 1-5 in., and more typically, the width of the lap line region is 3-4 in.

In another non-limiting embodiment, the fiber mat can be made wide enough to optionally overhang one or more edges of the bitumen roofing membrane to form a ready-made lap that ties into the adjacent membrane. This overhanging edge can have a length or width of 0.5-10 in. (and all values and ranges therebetween).

In another non-limiting embodiment, when the fiber mat is used to form a lap line region, the lap line region can optionally include a release material (e.g., polymeric liner, paper liner, etc.). Such release material can be of similar composition and thickness as the optional release liner that can be included in the bottom surface of the bitumen roofing membrane as discussed below, or can be of similar composition and thickness as the optional release film that can be included on the top surface of the fiber mat as discussed below.

In another non-limiting embodiment, when one or more fiber reinforcement layers are in the form of a fiber mat, the fiber mat may be a woven mat, a non-woven mat, a mat formed by non-overlapping fibers (e.g., rovings, etc.), or a mat formed by overlapping fibers. In one non-limiting configuration, the fiber mat is a woven mat. In another non-limiting configuration, the fiber material used to at least partially form the fiber mat is partially or fully formed of fibers that are 0.2-50 in. in length (and all values and ranges therebetween) and are optionally partially or fully held together by a binder (e.g., polymeric binder, etc.), stitching, and/or weaving; and typically the fiber mat is partially or fully formed of fibers that are 0.3-15 in. in length and are partially or fully held together by a binder and/or stitching and/or weaving. In another non-limiting arrangement, the fiber mat is formed of a plurality of fibers that are oriented in multiple directions from one another (e.g., multi-directional fiber mat) and such fibers are bonded together by a polymeric binder material (e.g., acrylic binder, etc.), stitched together, and/or weaved together and the length of the fibers is 0.1-10 in.

In another non-limiting embodiment, when one or more fiber reinforcement layers are in the form of a fiber mat, the fiber mat generally has an average thickness of at least 2 mil (0.002 in.) and typically has an average thickness than is up to 160 mil (0.16 in.) (and all values and ranges therebetween). In one non-limiting configuration, the fiber mat has an average thickness of 2-60 mil. In another non-limiting configuration, the fiber mat has an average thickness of 2-40 mil. In another non-limiting configuration, the fiber mat has an average thickness of 10-20 mil. Generally, the thickness ratio of the bitumen compound layer to the fiber mat is 1.3:1 to 33:1 (and all values and ranges therebetween). In one non-limiting arrangement, the thickness ratio of the bitumen compound layer to the fiber mat is 2:1 to 25:1. In another non-limiting arrangement, the thickness ratio of the bitumen compound layer to the fiber mat is 4:1 to 18:1.

In another non-limiting embodiment, the one or more fiber reinforcement layers can optionally be formed, treated, etc., to be wick resistant to inhibit or prevent moisture from moving through the one or more fiber reinforcement layers. As such, the one or more fiber reinforcement layers can a) be formed of a wick-resistant material; b) the knitting together of the fibers can be tight to inhibit or resist moisture penetration or wicking of moisture through the fabric layer; and/or c) the fibers and/or the fiber mat itself can be coated with a material that inhibits or resists moisture penetration or wicking of moisture through the one or more fiber reinforcement layers.

In another non-limiting embodiment, the one or more fiber reinforcement layers can optionally have fire-retardant properties. In non-limiting configuration, the fibers and/or the one or more fiber reinforcement layers can optionally be pre-treated and/or post-treated with one or more fire-retardant materials (e.g., halogenated compound-containing coatings, expandable graphite-containing coatings, etc.).

In another non-limiting embodiment, the one or more fiber reinforcement layers can optionally include a backing material. The backing material (when used) can be pre-coated on the bottom surface of the one or more fiber reinforcement layers. The backing material (when used) can be formed of a material that facilities in the securing of the one or more fiber reinforcement layers to a) the top surface of the bitumen compound layer; or b) the bottom surface of the bitumen compound layer. In one non-limiting configuration, the backing material is formed of a bitumen-or asphalt-containing material, a polymeric coating layer, or a polymeric sheet layer. In one non-limiting configuration, the composition of the backing material is different from the composition of the bitumen composition in the bitumen compound layer. The thickness of the backing material (when used) is generally at least 0.1 mil (0.0001 in.) and generally no more than 40 mils (0.04 in.) and all values and ranges therebetween).

### The Release Liner or Underside Material

A release liner can optionally form the bottom and/or top surface of the bitumen roofing membrane. Such release liner can be formed of a paper (e.g., kraft paper, super calendared kraft paper, clay-coated kraft paper, polymer-coated kraft paper, glazed paper, etc.) or a polymeric film (e.g., PET film, polypropylene film, polyolefins film, polyethylene films, PP films, etc.), or a paper that is coated with a polymeric film. The thickness of the release liner is generally 0.2-50 mil (and all values and ranges therebetween). In one non-limiting configuration, the thickness of the release liner (when used) is 1-10 mil.

### Particle Layer

Granules can optionally form at least a portion or all of the top surface of the bitumen roofing membrane. Generally, the granules are inert granules. Many types of granules can be used (e.g., repurposed, post-industrial coal slag, paint-coated granules, polymer-coated granules, metallic-coated granules, ceramic-coated granules, mineral-formed granules, composite-formed granules, etc.).

In one non-limiting embodiment, the granules are partially or fully formed of granules that can absorb and/or bind NOx, a major contributor to smog.

In one non-limiting embodiment, the granules are partially or fully formed of granules that can absorb and/or bind carbon dioxide. In one non-limiting configuration, the granules are partially or fully formed of olivine and/or serpentinite.

In another non-limiting embodiment, the granules generally have a size of at least 200 microns (e.g., 200 microns to 6 mm and all values and ranges therebetween; 450 microns to 1 mm, etc.). As can be appreciated, the size of the granules is non-limiting.

In one non-limiting configuration, the granules, when used as a top surface of the bitumen roofing membrane, have a solar reflectivity between 13-60% (per ASTM C1549) (and all values and ranges therebetween). In one non-limiting configuration, the granules, when used as a top surface of the bitumen roofing membrane, have a solar reflectivity between 15-50% (per ASTM C1549) (and all values and ranges therebetween). In one non-limiting configuration, the granules, when used as a top surface of the bitumen roofing membrane, have a solar reflectivity between 20-40% (and all values and ranges therebetween).

In another non-limiting embodiment, wherein the granules constitutes 0.1-60 wt. % of said bitumen roofing membrane (and all values and ranges therebetween).

### Packaging

The packaging for the bitumen roofing membrane can optionally be partially or fully formed of recyclable materials (e.g., recycled paper, recycled plastics, etc.). In one non-limiting embodiment, the packaging for the bitumen roofing membrane includes tape that is partially or fully formed of recycled materials, cardboard pallet base and/or top cover that are partially or fully formed of recycled material, cover bags that are placed over the rolls for storage that contain at least 1% (e.g., 1-50% and all values and ranges therebetween) plant-based resin and are at least partially biodegradable. In one non-limiting arrangement, at least 5% of the packaging for the bitumen roofing membrane includes recycled materials.

In one non-limiting object, there is provided a bitumen roofing membrane that is at least partially formed of recycled material.

In another and/or alternative non-limiting object, there is provided a bitumen roofing membrane that includes a blend of recycled and traditionally processed modifiers and sourced additives to create a more eco-friendly and sustainable roofing membrane while retaining the desired properties of a long-lasting roofing membrane, such as improved material retention, low temperature flexibility, and UV and oxidation resistance.

In another and/or alternative non-limiting object, there is provided a bitumen roofing membrane that has a reduced carbon footprint and is a more sustainable product by employing asphalt modifiers from non-traditional sources that do not rely on pollution-creating petrochemical manufacturing processes, but rather from post-industrial and post-consumer recycled and/or renewable sources that eliminate material from landfills.

In another and/or alternative non-limiting object, there is provided a bitumen roofing membrane that utilizes post-industrial and post-consumer recycled polymer materials to help improve the properties of the bitumen roofing material.

In another and/or alternative non-limiting object, there is provided a bitumen roofing membrane that uses recycled materials to provide a partial replacement of asphalt, with or without virgin polymers, to improve and strengthen the bitumen material.

In another and/or alternative non-limiting object, there is provided a bitumen roofing membrane that includes 1) a bitumen compound layer, 2) a fiber reinforcement (e.g., fiber mat, fiber strands, fibers, etc.) and optionally 3) one or more of a) an optional liquid applied coating that partially or fully encapsulates the fiber reinforcement, b) an optional release liner that is releasably positioned on the bottom surface of the bitumen roofing membrane, c) an optional release film that is releasably positioned on the top surface of the fiber mat, and/or d) an optional layer of particles on the top surface of the bitumen roofing membrane.

In another and/or alternative non-limiting object, there is provided a bitumen roofing membrane wherein the bitumen compound layer includes a primary hydrocarbon compound (e.g., bitumen or asphalt, coal tar); and optionally one or more of a) filler (e.g., calcium carbonate, chalk, clay, dolomite, kaolin, silica, talc, etc.); b) polymer modifier (e.g., APAO [amorphous polyolefin], APP [atactic polypropylene], EVA [ethylene vinyl acetate], EBA [ethylene butyl acrylate], PPA [polyphthalamide], PPI [polymeric polyisocyanate], PE [polyethylene], PP [polypropylene] SEBS [styrene ethylene butadiene styrene], SBS [styrene butadiene styrene], SIS [styrene-isoprene-styrene], thermoplastic urethane [TPU], etc.); c) hydrocarbon resin or process oil (e.g., naphthenic oil, paraffinic oil, C5-C9 aromatic hydrocarbon, etc.); d) ground tire rubber; e) tackifying agent; f) antioxidant; g) UV stabilizer; h) cross-linkers; i) biocide; j) coloring agent; k) metal flakes; l) adhesion enhancer; m) fire retardant (e.g., alumina trihydrate, ammonium polyphosphate, etc.); n) softening agent; o) wax (e.g., paraffin wax, etc.); p) acid (e.g., stearic acid, etc.); and/or q) reinforcement fibers (e.g., Kevlar®, carbon fibers, fiberglass, boron fibers, polyethylene fibers, polypropylene fibers, recycled polymer and/or plastic fibers, etc.).

In another and/or alternative non-limiting object, there is provided a bitumen roofing membrane wherein the bitumen compound layer includes a primary hydrocarbon compound and the primary hydrocarbon compound constitutes 25-90 wt. % (and all values and ranges therebetween) of the bitumen compound layer.

In another and/or alternative non-limiting object, there is provided a bitumen roofing membrane wherein the bitumen compound layer includes a filler and wherein the filler constitutes about 0.5-66 wt. % (and all values and ranges therebetween) of the bitumen compound layer.

In another and/or alternative non-limiting object, there is provided a bitumen roofing membrane wherein the bitumen compound layer includes a filler and wherein the filler include one or more of calcium carbonate (e.g., oyster shells and other shells of marine organisms, snail shells, coal balls, pearls, eggshells, chalk, limestone, etc.), clay (e.g., recycled tile, recycled clay plates, recycled porcelain, recycled dishes, recycled pots, etc.), dolomite, kaolin (e.g., recycled porcelain, recycled china, feldspar, etc.), silica, talc, etc.; however, other or additional filler can be used. In one non-limiting formulation, the filler (when used) includes calcium carbonate, silica, and/or talc.

In another and/or alternative non-limiting object, there is provided a bitumen roofing membrane wherein the bitumen compound layer includes a filler and 5-100% (and all values and ranges therebetween) of the one or more other fillers come from a recycled and/or non-mined source.

In another and/or alternative non-limiting object, there is provided a bitumen roofing membrane wherein the bitumen compound layer includes a polymer modifier, and wherein the polymer modifier constitutes about 0.05-30 wt. % (and all values and ranges therebetween) of the bitumen compound layer.

In another and/or alternative non-limiting object, there is provided a bitumen roofing membrane wherein the bitumen compound layer includes a polymer modifier, and wherein the polymer modifier includes one or more of APAO (amorphous polyolefin), APP (atactic polypropylene), EVA (ethylene vinyl acetate), EBA (ethylene butyl acrylate), PPA (polyphthalamide), PPI (polymeric polyisocyanate), PE (polyethylene), PP (polypropylene), SEBS (styrene ethylene butadiene styrene), SBS (styrene butadiene styrene), SIS (styrene-isoprene-styrene), SBR (styrene-butadiene-rubber), thermoplastic urethane (TPU), etc.

In another and/or alternative non-limiting object, there is provided a bitumen roofing membrane wherein the bitumen compound layer includes a polymer modifier, and wherein the polymer modifier includes 0.5-100% (and all values and ranges therebetween) recycled polymer material.

In another and/or alternative non-limiting object, there is provided a bitumen roofing membrane wherein the bitumen compound layer includes a polymer modifier, and wherein the polymer modifier includes recycled plastics and/or polymer includes recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycles synthesized plastics, etc.

In another and/or alternative non-limiting object, there is provided a bitumen roofing membrane wherein the bitumen compound layer includes a process oil or hydrocarbon resin, and wherein the process oil or hydrocarbon resin is about 0.05-30 wt. % (and all values and ranges therebetween) of the bitumen compound layer.

In another and/or alternative non-limiting object, there is provided a bitumen roofing membrane wherein the bitumen compound layer includes ground tire rubber, and wherein the ground tire rubber is about 0.5-25 wt. % (and all values and ranges therebetween) of the bitumen compound layer.

In another and/or alternative non-limiting object, there is provided a bitumen roofing membrane wherein the bitumen compound layer includes ground tire rubber, and wherein the average particle size of the ground tire rubber is no greater than 100 mesh (149 microns).

In another and/or alternative non-limiting object, there is provided a bitumen roofing membrane wherein the bitumen compound layer includes ground tire rubber, and wherein the average particle size of the ground tire rubber is 100 mesh (149 microns) to 400 mesh (37 microns) (and all values and ranges therebetween).

In another and/or alternative non-limiting object, there is provided a bitumen roofing membrane wherein the bitumen compound layer includes ground tire rubber, and wherein the tire rubber includes one or more of butadiene rubber, styrene butadiene rubber, and optionally natural rubber.

In another and/or alternative non-limiting object, there is provided a bitumen roofing membrane that includes one or more fiber reinforcement layers as a reinforcement for the bitumen roofing membrane.

In another and/or alternative non-limiting object, there is provided a bitumen roofing membrane that includes one or more fiber reinforcement layers that can be a) applied on or above the top surface of the bitumen compound layer, b) applied on or below the bottom surface of the bitumen compound layer, or c) be impregnated or otherwise positioned within the bitumen compound layer.

In another and/or alternative non-limiting object, there is provided a bitumen roofing membrane that includes one or more fiber reinforcement layers that can be in the form of woven mat, non-woven mat, woven and non-woven mat, sheet, one or more rovings, one or more rows of rovings, etc.

In another and/or alternative non-limiting object, there is provided a bitumen roofing membrane that includes one or more fiber reinforcement layers wherein 0.5-100 wt. % (and all values and ranges therebetween) of the fiber reinforcement layer is formed of a recycled polymer material (e.g., recycled polyethylene bottles and/or containers, recycled polypropylene bottles and/or containers, etc.; recycled plastic or polymer components from vehicles [e.g., plastic window and windshield trim, etc.]; recycled plastic or polymers from other sources [e.g., plastic agricultural products, consumer bags, plastic from recycled consumer products and appliances, recycles vinyl siding, recycles plastic panels, recycled industrial equipment, etc.]; recycled polyolefin plastics; recycled synthesized plastics; etc.).

In another and/or alternative non-limiting object, there is provided a bitumen roofing membrane that includes one or more fiber reinforcement wherein the fiber replacement layers are partially or fully saturated/encapsulated with the bitumen compound layer.

In another and/or alternative non-limiting object, there is provided a bitumen roofing membrane that includes one or more fiber reinforcement layers, and wherein a thickness ratio of the bitumen compound layer to the fiber reinforcement layer is 1.1:1 to 35:1 (and all values and ranges therebetween).

In another and/or alternative non-limiting object, there is provided a bitumen roofing membrane that includes one or more fiber reinforcement layers, and wherein the one or more fiber reinforcement layers can a) be formed of a wick-resistant material; b) the knitting together of the fibers can be tight to inhibit or resist moisture penetration or wicking of moisture through the fabric layer; and/or c) the fibers and/or the fiber mat itself can be coated with a material that inhibits or resists moisture penetration or wicking of moisture through the one or more fiber reinforcement layers.

In another and/or alternative non-limiting object, there is provided a bitumen roofing membrane that includes one or more fiber reinforcement layers, and wherein the one or more fiber reinforcement layers can optionally have fire-retardant properties.

In another and/or alternative non-limiting object, there is provided a bitumen roofing membrane that includes a release liner that forms the bottom and/or top surface of the bitumen roofing membrane.

In another and/or alternative non-limiting object, there is provided a bitumen roofing membrane that includes granules that form at least a portion or all of the top surface of the bitumen roofing membrane.

In another and/or alternative non-limiting object, there is provided a bitumen roofing membrane that includes granules that partially or fully formed of a material that can absorb and/or bind carbon dioxide.

In another and/or alternative non-limiting object, there is provided a bitumen roofing membrane that includes granules that include olivine and/or serpentinite.

In another and/or alternative non-limiting object, there is provided a bitumen roofing membrane that is packaged by materials that are partially or fully formed of recyclable materials (e.g., recycled paper, recycled plastics, etc.).

In another and/or alternative non-limiting object, there is provided a bitumen roofing membrane that is packaged by materials that includes tape that is partially or fully formed of recycled materials, cardboard pallet base and/or top cover that are partially or fully formed of recycled material, cover bags that are placed over the rolls for storage that contain at least 1% (e.g., 1-50% and all values and ranges therebetween) plant-based resin and are at least partially biodegradable.

Other objects, advantages, and novel features of the present disclosure will become apparent from the following detailed description of the disclosure.

### DETAILED DESCRIPTION OF VARIOUS NON-EMBODIMENTS OF DISCLOSURE

A more complete understanding of the articles/devices, processes and components disclosed herein can be obtained by reference to the accompanying drawings. These figures are merely schematic representations based on convenience and the case of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

The present disclosure is directed to an improved roofing membrane system that includes a blend of recycled and traditionally processed modifiers and sourced additives to create a more eco-friendly and sustainable roofing membrane while retaining the desired properties of a long-lasting roofing membrane such as improved material retention, low temperature flexibility, and UV and oxidation resistance. The bitumen roofing membrane has a reduced carbon footprint and is a more sustainable product by employing asphalt modifiers from non-traditional sources that do not rely on pollution-creating petrochemical manufacturing processes, but rather from post-industrial and post-consumer recycled and/or renewable sources that eliminate material from landfills. The bitumen roofing membrane utilizes post-industrial and post-consumer recycled polymer materials to help improve the properties of the bitumen roofing material. Recycled materials are provided as a partial replacement of asphalt, with or without virgin polymers, to improve and strengthen the bitumen material of the bitumen roofing membrane.

The bitumen roofing membrane includes 1) a bitumen compound layer, 2) a fiber reinforcement (e.g., fiber mat, fiber strands, fibers, etc.) and optionally 3) one or more of a) an optional release liner that is releasably positioned on the bottom surface of the bitumen roofing membrane, b) an optional release film that is releasably positioned on the top surface of the fiber mat, and/or c) an optionally layer of particles on the top surface of the bitumen roofing membrane.

The bitumen compound layer includes a primary hydrocarbon compound (e.g., bitumen or asphalt, coal tar); and optionally one or more of a) filler (e.g., calcium carbonate, chalk, clay, dolomite, kaolin, silica, talc, etc.); b) polymer modifier (e.g., APAO [amorphous polyolefin], APP [atactic polypropylene], EVA [ethylene vinyl acetate], EBA [ethylene butyl acrylate], PPA [polyphthalamide], PPI [polymeric polyisocyanate], PE [polyethylene], PP [polypropylene] SEBS [styrene ethylene butadiene styrene], SBS [styrene butadiene styrene], SIS [styrene-isoprene-styrene], thermoplastic urethane [TPU], etc.); c) hydrocarbon resin or process oil (e.g., naphthenic oil, paraffinic oil, C5-C9 aromatic hydrocarbon, etc.); d) ground tire rubber; c) tackifying agent; f) antioxidant; g) UV stabilizer; h) cross-linkers; i) biocide; j) coloring agent; k) metal flakes; l) adhesion enhancer; m) fire retardant (e.g., alumina trihydrate, ammonium polyphosphate, etc.); n) softening agent; o) wax (e.g., paraffin wax, etc.); p) acid (e.g., stearic acid, etc.); and/or q) reinforcement fibers (e.g., Kevlar®, carbon fibers, fiberglass, boron fibers, polyethylene fibers, polypropylene fibers, recycled polymer and/or plastic fibers, etc.).

The primary hydrocarbon compound constitutes 25-90 wt. % (and all values and ranges therebetween) of the bitumen compound layer.

The filler, when included in the bitumen compound layer, constitutes about 0.5-66 wt. % (and all values and ranges therebetween) of the bitumen compound layer.

The filler can include one or more of calcium carbonate (e.g., oyster shells and other shells of marine organisms, snail shells, coal balls, pearls, eggshells, chalk, limestone, etc.), clay (e.g., recycled tile, recycled clay plates, recycled porcelain, recycled dishes, recycled pots, etc.), dolomite, kaolin (e.g., recycled porcelain, recycled china, feldspar, etc.), silica, talc, etc.; however, other or additional filler can be used. 5-100% (and all values and ranges therebetween) of the one or more other fillers comes from a recycled and/or non-mined source.

The polymer modifier, when included in the bitumen compound layer, constitutes about 0.05-30 wt. % (and all values and ranges therebetween) of the bitumen compound layer.

The polymer modifier can include one or more of APAO (amorphous polyolefin), APP (atactic polypropylene), EVA (ethylene vinyl acetate), EBA (ethylene butyl acrylate), PPA (polyphthalamide), PPI (polymeric polyisocyanate), PE (polyethylene), PP (polypropylene), SEBS (styrene ethylene butadiene styrene), SBS (styrene butadiene styrene), SIS (styrene-isoprene-styrene), SBR (styrene-butadiene-rubber), thermoplastic urethane (TPU), etc.; however, other or additional polymer modifier can be used. In one non-limiting formulation, the polymer modifier includes SBS and/or polyurethane.

The polymer modifier includes 0.5-100% (and all values and ranges therebetween) recycled polymer material (e.g., recycled plastic bottles (e.g., recycled polyethylene bottles and/or containers, recycled polypropylene bottles and/or containers, etc.), recycled plastic or polymer components from vehicles (e.g., plastic window and windshield trim, etc.), recycled plastic or polymers from other sources (e.g., plastic agricultural products, consumer bags, plastic from recycled consumer products and appliances, recycles vinyl siding, recycles plastic panels, recycled industrial equipment, etc.), recycled polyolefin plastics, recycled synthesized plastics, etc.).

The process oil or hydrocarbon resin, when included in the bitumen compound layer, is about 0.05-30 wt. % (and all values and ranges therebetween) of the bitumen compound layer.

The ground tire rubber, when included in the bitumen compound layer, is about 0.5-25 wt. % (and all values and ranges therebetween) of the bitumen compound layer. The average particle size of the ground tire rubber that no greater than 100 mesh (149 microns).

The antioxidant, when included in the bitumen compound layer, is about 0.01-30 wt. % (and all values and ranges therebetween) of the bitumen compound layer.

The UV stabilizer, when included in the bitumen compound layer, is about 0.01-30 wt. % (and all values and ranges therebetween) of the bitumen compound layer.

The cross-linkers, when included in the bitumen compound layer, are about 0.05-30 wt. % (and all values and ranges therebetween) of the bitumen compound layer.

The biocide, when included in the bitumen compound layer, is about 0.05-30 wt. % (and all values and ranges therebetween) of the bitumen compound layer.

The coloring agent, when included in the bitumen compound layer, is about 0.05-30 wt. % (and all values and ranges therebetween) of the bitumen compound layer.

The metal flakes, when included in the bitumen compound layer, are about 0.05-30 wt. % (and all values and ranges therebetween) of the bitumen compound layer.

The adhesion enhancer, when included in the bitumen compound layer, is about 0.05-30 wt. % (and all values and ranges therebetween) of the bitumen compound layer.

The fire retardant, when included in the bitumen compound layer, is about 0.05-30 wt. % (and all values and ranges therebetween) of the bitumen compound layer.

The tackifying agent, when included in the bitumen compound layer, is about 0.05-30 wt. % (and all values and ranges therebetween) of the bitumen compound layer.

The softening agent, when included in the bitumen compound layer, is about 0.05-30 wt. % (and all values and ranges therebetween) of the bitumen compound layer.

The wax, when included in the bitumen compound layer, is about 0.05-15 wt. % (and all values and ranges therebetween) of the bitumen compound layer.

The acid, when included in the bitumen compound layer, is about 0.05-15 wt. % (and all values and ranges therebetween) of the bitumen compound layer.

The reinforcement fibers, when included in the bitumen compound layer, are about 0.05-40 wt. % (and all values and ranges therebetween) of the bitumen compound layer. The reinforcement fibers can include one or more of aramid fibers (e.g., poly-para-phenylene terephthalamide [Kevlar®]), carbon fibers, fiberglass, boron fibers, polyethylene fibers, polypropylene fibers, recycled polymer and/or plastic fibers. The reinforcement fibers are formed of 0.5-100% (and all values and ranges therebetween) recycled polymer material.

The thickness of the entire bitumen compound layer is generally 10-250 mil (0.01-0.25 in.) (and all values and ranges therebetween).

One non-limiting example of the composition of the bitumen compound layer (absent any optional fiber reinforcement layer) are as follows:

### Example A

| | | |
|---|---|---|
| Primary hydrocarbon compound | 25-90 | wt. % |
| Filler | 0-66 | wt. % |
| Polymer Modifier | 0-30 | wt. % |
| Hydrocarbon Resin Process Oil | 0-30 | wt. % |
| Ground Tire Rubber (no greater than | 0.5-25 | wt. % |
| 100 mesh (149 microns) average size) | | |
| Antioxidant | 0-30 | wt. % |
| UV Stabilizer | 0-30 | wt. % |
| Cross-Linker | 0-30 | wt. % |
| Biocide | 0-30 | wt. % |
| Coloring Agent | 0-30 | wt. % |
| Metal Flakes | 0-30 | wt. % |
| Adhesion Enhancer | 0-30 | wt. % |
| Fire Retardant | 0-30 | wt. % |
| Tackifying Agent | 0-30 | wt. % |
| Softening Agent | 0-30 | wt. % |
| Wax | 0-15 | wt. % |
| Acid | 0-15 | wt. % |
| Fiber reinforcement | 0-40 | wt. % |

and wherein the polymer modifier, filler, and/or the fiber reinforcement includes 0-100 wt. % (and all values and ranges therebetween) recycled material.

One or more fiber reinforcement layers can optionally be used as a reinforcement for the bitumen roofing membrane. The one or more fiber reinforcement layers (when used) can be a) applied on or above the top surface of the bitumen compound layer, b) applied on or below the bottom surface of the bitumen compound layer, or c) impregnated or otherwise positioned within the bitumen compound layer. As can be appreciated, multiple fiber reinforcement layers can be used.

The fiber reinforcement layer can be in the form of woven mat, non-woven mat, woven and nonwoven mat, sheet, one or more rovings, one or more rows of rovings, etc.

The fiber reinforcement layer can be formed of one or more of fiberglass, nylon, polyester, cotton, silk, wool, hemp, straw, bamboo, flax, jute, modal, asbestos fibers, basalt fibers, aramid fiber, acrylic fiber, polyurethane fiber, olefin fiber, rayon fiber, polylactide fiber, lurex fiber, carbon fibers, boron fibers, polyethylene fibers, aromatic polyamide or aramid fibers (e.g., Kevlar™, Twaron™, etc.), polyethylene fibers, polypropylene fibers, recycled polymer fibers, recycled, plastic fibers, and any blend of these materials. In one non-limiting embodiment, 0.5-100 wt. % (and all values and ranges therebetween) of the fiber reinforcement layer is formed of a recycled polymer material (e.g., recycled polyethylene bottles and/or containers, recycled polypropylene bottles and/or containers, etc.; recycled plastic or polymer components from vehicles [e.g., plastic window and windshield trim, etc.]; recycled plastic or polymers from other sources [e.g., plastic agricultural products, consumer bags, plastic from recycled consumer products and appliances, recycles vinyl siding, recycles plastic panels, recycled industrial equipment, etc.]; recycled polyolefin plastics; recycled synthesized plastics; etc.).

The one or more reinforcement layers can be partially or fully saturated/encapsulated with the bitumen compound layer; however, this is not required.

The one or more reinforcement layers are generally flexible to enable the bitumen compound layer to be rolled into a roll of bitumen compound layer which would otherwise cause damage to the bitumen compound layer.

The fiber reinforcement layer generally extends 1-100% (and all values and ranges therebetween) of the width of the bitumen compound layer, and 1-100% (and all values and ranges therebetween) of the length of the bitumen compound layer.

The thickness of each of the fiber reinforcement layers is generally at least 1 mil (e.g., 1-200 mil [(0.001-0.2 in.] and all values and ranges therebetween). The thickness ratio of the bitumen compound layer to the fiber reinforcement layer is 1.1:1 to 35:1 (and all values and ranges therebetween).

The one or more fiber reinforcement layers can optionally be formed, treated, etc., to be wick resistant to inhibit or prevent moisture from moving through the one or more fiber reinforcement layers.

The one or more fiber reinforcement layers can optionally have fire-retardant properties.

A release liner can optionally form the bottom and/or top surface of the bitumen roofing membrane. Such release liner can be formed of a paper (e.g., kraft paper, super calendared kraft paper, clay-coated kraft paper, polymer-coated kraft paper, glazed paper, etc.) or a polymeric film (e.g., PET film, polypropylene film, polyolefins film, polyethylene films, PP films, etc.), or a paper that is coated with a polymeric film. The thickness of the release liner is generally 0.2-50 mil (and all values and ranges therebetween).

The top surface of the bitumen roofing membrane can optionally include granules (e.g., paint-coated granules, polymer-coated granules, metallic-coated granules, ceramic-coated granules, mineral-formed granules, composite-formed granules, etc.). The granules can be partially or fully formed of granules that can absorb and/or bind carbon dioxide (e.g., granules are partially or fully formed of olivine and/or serpentinite). The granules generally have a size of at least 200 microns (e.g., 200 microns to 6 mm and all values and ranges therebetween; 450 microns to 1 mm, etc.).

The packaging for the bitumen roofing membrane can optionally be partially or fully formed of recyclable materials (e.g., recycled paper, recycled plastics, etc.).

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

The description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. A bitumen roofing membrane that includes a bitumen compound layer and a fiber reinforcement layer; said fiber reinforcement layer is positioned on a top surface, on a bottom surface, and/or at least partially or fully inside the bitumen compound layer; said bitumen compound layer includes a primary hydrocarbon compound and one or more of a) filler; b) polymer modifier; c) hydrocarbon resin or process oil; d) ground tire rubber; e) tackifying agent; f) antioxidant; g) UV stabilizer; h) cross-linkers; i) biocide; j) coloring agent; k) metal flakes; l) adhesion enhancer; m) fire retardant; n) softening agent; o) wax; p) acid; and q) reinforcement fibers; and wherein said polymer modifier, said filler, and/or said fiber reinforcement includes 0.5-100 wt. % recycled material.

2. The bitumen roofing membrane as defined in claim 1, wherein said bitumen compound layer comprises by weight percent:

| | | |
|---|---|---|
| Primary hydrocarbon compound | 25-90 | wt. % |
| Filler | 0-66 | wt. % |
| Polymer Modifier | 0-30 | wt. % |
| Hydrocarbon Resin Process Oil | 0-30 | wt. % |
| Ground Tire Rubber | 0.5-25 | wt. % |
| Antioxidant | 0-30 | wt. % |
| UV Stabilizer | 0-30 | wt. % |
| Cross-Linker | 0-30 | wt. % |
| Biocide | 0-30 | wt. % |
| Coloring Agent | 0-30 | wt. % |
| Metal Flakes | 0-30 | wt. % |
| Adhesion Enhancer | 0-30 | wt. % |
| Fire Retardant | 0-30 | wt. % |
| Tackifying Agent | 0-30 | wt. % |
| Softening Agent | 0-30 | wt. % |
| Wax | 0-15 | wt. % |
| Acid | 0-15 | wt. % |
| Fiber reinforcement | 0-40 | wt. % |

and wherein said polymer modifier, said filler, and/or said fiber reinforcement includes 1-100 wt. % recycled material, and wherein said Ground Tire Rubber has a size that is no greater than 100 mesh (149 microns) average size.

3. The bitumen roofing membrane as defined in claim 1, wherein said bitumen compound layer comprises by weight percent:

| | | |
|---|---|---|
| Primary hydrocarbon compound | 25-80 | wt. % |
| Filler | 0.5-60 | wt. % |
| Polymer Modifier | 0.05-25 | wt. % |
| Ground Tire Rubber | 0.5-20 | wt. % |
| Hydrocarbon Resin Process Oil | 0-20 | wt. % |
| Antioxidant | 0-5 | wt. % |
| UV Stabilizer | 0-5 | wt. % |
| Cross-Linker | 0-10 | wt. % |
| Biocide | 0-5 | wt. % |
| Coloring Agent | 0-5 | wt. % |
| Metal Flakes | 0-5 | wt. % |
| Adhesion Enhancer | 0-5 | wt. % |
| Fire Retardant | 0-25 | wt. % |
| Tackifying Agent | 0-5 | wt. % |
| Softening Agent | 0-5 | wt. % |
| Wax | 0-5 | wt. % |
| Acid | 0-5 | wt. % |
| Fiber reinforcement | 0-30 | wt. % |

and wherein said polymer modifier, said filler, and/or said fiber reinforcement includes 1-100 wt. % recycled material, and wherein said Ground Tire Rubber has a size that is no greater than 100 mesh (149 microns) average size.

4. The bitumen roofing membrane as defined in claim 1, wherein said bitumen compound layer comprises by weight percent:

| | | |
|---|---|---|
| Primary hydrocarbon compound | 25-60 | wt. % |
| Filler | 0.5-50 | wt. % |
| Polymer Modifier | 0.05-20 | wt. % |
| Ground Tire Rubber | 0.5-15 | wt. % |
| Hydrocarbon Resin Process Oil | 0-15 | wt. % |
| Antioxidant | 0-2 | wt. % |
| UV Stabilizer | 0-2 | wt. % |
| Cross-Linker | 0-5 | wt. % |
| Biocide | 0-2 | wt. % |
| Coloring Agent | 0-2 | wt. % |
| Metal Flakes | 0-2 | wt. % |
| Adhesion Enhancer | 0-2 | wt. % |
| Fire Retardant | 0-20 | wt. % |
| Tackifying Agent | 0-2 | wt. % |
| Softening Agent | 0-2 | wt. % |
| Wax | 0-2 | wt. % |
| Acid | 0-2 | wt. % |
| Fiber reinforcement | 0-25 | wt. % |

and wherein said polymer modifier, said filler, and/or said fiber reinforcement includes 1-100 wt. % recycled material, and wherein said Ground Tire Rubber has a size that is no greater than 100 mesh (149 microns) average size.

5. The bitumen roofing membrane as defined in claim 1, wherein said bitumen compound layer comprises by weight percent:

| | | |
|---|---|---|
| Primary hydrocarbon compound | 25-55 | wt. % |
| Filler | 0.05-45 | wt. % |
| Polymer Modifier | 0.05-10 | wt. % |
| Ground Tire Rubber | 1-12 | wt. % |
| Hydrocarbon Resin Process Oil | 0-5 | wt. % |
| Antioxidant | 0-2 | wt. % |
| UV Stabilizer | 0-2 | wt. % |
| Cross-Linker | 0-5 | wt. % |
| Biocide | 0-1 | wt. % |
| Coloring Agent | 0-2 | wt. % |
| Metal Flakes | 0-2 | wt. % |
| Adhesion Enhancer | 0-2 | wt. % |
| Fire Retardant | 0-20 | wt. % |
| Tackifying Agent | 0-2 | wt. % |
| Softening Agent | 0-2 | wt. % |
| Wax | 0-4 | wt. % |
| Acid | 0-2 | wt. % |
| Fiber reinforcement | 0-20 | wt. % |

and wherein said polymer modifier, said filler, and/or said fiber reinforcement includes 10-100 wt. % recycled material, and wherein said Ground Tire Rubber has a size of 100-200 mesh (149-74 microns) average size.

6. The bitumen roofing membrane as defined in claim 1, wherein said bitumen compound layer comprises by weight percent:

| | | |
|---|---|---|
| Primary hydrocarbon compound | 40-80 | wt. |
| Filler | 0-60 | wt. % |
| Polymer Modifier | 1-25 | wt. % |
| Ground Tire Rubber | 0.5-15 | wt. % |
| Hydrocarbon Resin or Process Oil | 0-15 | wt. % |
| Antioxidant | 0-1 | wt. % |
| UV Stabilizer | 0-1 | wt. % |
| Biocide | 0-1 | wt. % |
| Wax | 0-4 | wt. % |
| Fire Retardant | 0-18 | wt. % |
| Fiber reinforcement | 0-15 | wt. % |

and wherein said polymer modifier, said filler, and/or said fiber reinforcement includes 20-100 wt. % recycled material, and wherein said Ground Tire Rubber has a size of 100-200 mesh (149-74 microns) average size.

7. The bitumen roofing membrane as defined in claim 1, wherein said bitumen compound layer comprises by weight percent:

| | | |
|---|---|---|
| Primary hydrocarbon compound | 25-65 | wt. % |
| Filler | 5-40 | wt. % |
| Polymer Modifier | 2-20 | wt. % |
| Hydrocarbon Resin or Process Oil | 0-15 | wt. % |
| Antioxidant | 0-1 | wt. % |
| UV Stabilizer | 0-1 | wt. % |
| Biocide | 0-1 | wt. % |
| Wax | 0-3 | wt. % |
| Fire Retardant | 0.05-15 | wt. % |
| Fiber reinforcement | 0-15 | wt. % |

and wherein said polymer modifier, said filler, and/or said fiber reinforcement includes 20-100 wt. % recycled material.

8. The bitumen roofing membrane as defined in claim 1, wherein said bitumen compound layer comprises by weight percent:

| | | |
|---|---|---|
| Primary hydrocarbon compound | 40-60 | wt. % |
| Filler | 5-25 | wt. % |
| Polymer Modifier | 8-20 | wt. % |
| Hydrocarbon Resin or Process Oil | 0-10 | wt. % |
| Antioxidant | 0-1 | wt. % |
| UV Stabilizer | 0-1 | wt. % |
| Biocide | 0-1 | wt. % |
| Wax | 0-3 | wt. % |
| Fire Retardant | 1-15 | wt. % |
| Fiber reinforcement | 0-10 | wt. % |

and wherein said polymer modifier, said filler, and/or said fiber reinforcement includes 30-100 wt. % recycled material.

9. The bitumen roofing membrane as defined in claim 1, wherein 60-100 wt. % of said fiber reinforcement layer is formed of a recycled polymer material.

10. The bitumen roofing membrane as defined in claim 8, wherein 60-100 wt. % of said fiber reinforcement layer is formed of a recycled polymer material.

11. The bitumen roofing membrane as defined in claim 1, wherein said bitumen roofing membrane includes said polymer modifier; 60-100 wt. % of said polymer modifier is formed of a recycled polymer material.

12. The bitumen roofing membrane as defined in claim 10, wherein said bitumen roofing membrane includes said polymer modifier; 60-100 wt. % of said polymer modifier is formed of a recycled polymer material.

13. The bitumen roofing membrane as defined in claim 10, wherein said bitumen roofing membrane includes said filler; 60-100 wt. % of said filler is formed of a recycled polymer material.

14. The bitumen roofing membrane as defined in claim 12, wherein said bitumen roofing membrane includes said filler; 60-100 wt. % of said filler is formed of a recycled polymer material.

15. The bitumen roofing membrane as defined in claim 1, further including a release liner; said release liner forms the bottom and/or top surface of the bitumen roofing membrane; said release liner is formed of one or more of paper, a polymeric film, or paper that is coated with polymeric film.

16. The bitumen roofing membrane as defined in claim 14, further including a release liner; said release liner forms the bottom and/or top surface of the bitumen roofing membrane; said release liner is formed of one or more of paper, a polymeric film, or paper that is coated with polymeric film.

17. The bitumen roofing membrane as defined in claim 1, further includes granules; said granules forming at least a portion of a top surface of said bitumen roofing membrane; said granules at least partially formed of a material that a) absorbs and/or binds carbon dioxide, and/or b) absorbs and/or binds NOₓ.

18. The bitumen roofing membrane as defined in claim 16, further includes granules; said granules forming at least a portion of a top surface of said bitumen roofing membrane; said granules at least partially formed of a material that a) absorbs and/or binds carbon dioxide, and/or b) absorbs and/or binds NOₓ.

19. The bitumen roofing membrane as defined in claim 1, further including packaging for said bitumen roofing membrane; said packaging partially or fully formed of recyclable materials.

20. The bitumen roofing membrane as defined in claim 18, further including packaging for said bitumen roofing membrane; said packaging partially or fully formed of recyclable materials.

21. The bitumen roofing membrane as defined in claim 19, wherein said packaging includes a) tape that is partially or fully formed of recycled materials, b) a cardboard pallet base that is partially or fully formed of recycled materials, c) a top packaging cover that is partially or fully formed of recycled material, d) rope or twine use to partially or fully secure a roll of bitumen roofing membrane that is partially or fully formed of recycled materials, e) paper wrapping used to partially or fully wrap a roof of bitumen roofing membrane that is partially or fully formed of recycled materials, f) paper or cardboard box that is partially or fully formed of recycled materials, and/or g) a cover bag that is placed over a roll of bitumen roofing membrane that is partially or fully formed of recycled material.

22. The bitumen roofing membrane as defined in claim 20, wherein said packaging includes a) tape that is partially or fully formed of recycled materials, b) a cardboard pallet base that is partially or fully formed of recycled materials, c) a top packaging cover that is partially or fully formed of recycled material, d) rope or twine use to partially or fully secure a roll of bitumen roofing membrane that is partially or fully formed of recycled materials, e) paper wrapping used to partially or fully wrap a roof of bitumen roofing membrane that is partially or fully formed of recycled materials, f) paper or cardboard box that is partially or fully formed of recycled materials, and/or g) a cover bag that is placed over a roll of bitumen roofing membrane that is partially or fully formed of recycled material.

23. A bitumen roofing membrane that includes a bitumen compound layer, a fiber reinforcement layer, and granules; said fiber reinforcement layer is positioned on a top surface, on a bottom surface, and/or at least partially or fully inside the bitumen compound layer; said bitumen compound layer includes a primary hydrocarbon compound and one or more of a) filler; b) polymer modifier; c) hydrocarbon resin or process oil; d) ground tire rubber; e) tackifying agent; f) antioxidant; g) UV stabilizer; h) cross-linkers; i) biocide; j) coloring agent; k) metal flakes; l) adhesion enhancer; m) fire retardant; n) softening agent; o) wax; p) acid; and q) reinforcement fibers; and wherein I) said polymer modifier, said filler, and/or said fiber reinforcement includes 10-100 wt. % recycled material, and/or II) said fiber reinforcement layer includes 10-100 wt. % recycled material; said granules forming at least a portion of a top surface of said bitumen roofing membrane; said granules are at least partially formed of a material that a) absorbs and/or binds carbon dioxide, b) absorbs and/or binds NOₓ, and/or c) results in a top surface of said bitumen roofing membrane having a reflectivity of 13-60% (per ASTM C1549); said bitumen compound layer comprises by weight percent:

| | | |
|---|---|---|
| Primary hydrocarbon compound | 40-60 | wt. % |
| Filler | 5-25 | wt. % |
| Polymer Modifier | 8-20 | wt. % |
| Hydrocarbon Resin or Process Oil | 0-10 | wt. % |
| Ground Tire Rubber | 0-25 | wt. % |
| Antioxidant | 0-1 | wt. % |
| UV Stabilizer | 0-1 | wt. % |
| Cross-Linker | 0-20 | wt. % |
| Biocide | 0-1 | wt. % |
| Wax | 0-3 | wt. % |
| Coloring Agent | 0-10 | wt. % |
| Metal Flakes | 0-10 | wt. % |
| Adhesion Enhancer | 0-10 | wt. % |
| Fire Retardant | 1-15 | wt. % |
| Fiber reinforcement | 0-10 | wt. % |
| Tackifying Agent | 0-10 | wt. % |
| Softening Agent | 0-10 | wt. % |
| Wax | 0-5 | wt. % |
| Acid | 0-5 | wt. %; |

and wherein said Ground Tire Rubber has a size of no greater than 100 mesh (149 microns) average size.

24. The bitumen roofing membrane as defined in claim 23, wherein 60-100 wt. % of said fiber reinforcement layer is formed of a recycled polymer material, and wherein 60-100 wt. % of said polymer modifier is formed of a recycled polymer material, and wherein 60-100 wt. % of said filler includes recycled material.

25. The bitumen roofing membrane as defined in claim 23, further including a release liner; said release liner forms the bottom and/or top surface of the bitumen roofing membrane; said release liner is formed of one or more of paper, a polymeric film, or paper that is coated with polymeric film.

26. The bitumen roofing membrane as defined in claim 24, further including a release liner; said release liner forms the bottom and/or top surface of the bitumen roofing membrane; said release liner is formed of one or more of paper, a polymeric film, or paper that is coated with polymeric film.

27. The bitumen roofing membrane as defined in claim 23, wherein said granules results in a top surface of said bitumen roofing membrane having a reflectivity of 13-60% (per ASTM C1549); said granules are at least partially formed of a material that a) absorbs and/or binds carbon dioxide, and/or b) absorbs and/or binds NOₓ.

28. The bitumen roofing membrane as defined in claim 26, wherein said granules results in a top surface of said bitumen roofing membrane having a reflectivity of 13-60% (per ASTM C1549); said granules are at least partially formed of a material that a) absorbs and/or binds carbon dioxide, and/or b) absorbs and/or binds NOₓ.

29. The bitumen roofing membrane as defined in claim 23, further including packaging for said bitumen roofing membrane; said packaging partially or fully formed of recyclable materials.

30. The bitumen roofing membrane as defined in claim 28, further including packaging for said bitumen roofing membrane; said packaging partially or fully formed of recyclable materials.

31. The bitumen roofing membrane as defined in claim 29, wherein said packaging includes a) tape that is partially or fully formed of recycled materials, b) a cardboard pallet base that is partially or fully formed of recycled materials, c) a top packaging cover that is partially or fully formed of recycled material, d) rope or twine use to partially or fully secure a roll of bitumen roofing membrane that is partially or fully formed of recycled materials, e) paper wrapping used to partially or fully wrap a roof of bitumen roofing membrane that is partially or fully formed of recycled materials, f) paper or cardboard box that is partially or fully formed of recycled materials, and/or g) a cover bag that is placed over a roll of bitumen roofing membrane that is partially or fully formed of recycled material.

32. The bitumen roofing membrane as defined in claim 30, wherein said packaging includes a) tape that is partially or fully formed of recycled materials, b) a cardboard pallet base that is partially or fully formed of recycled materials, c) a top packaging cover that is partially or fully formed of recycled material, d) rope or twine use to partially or fully secure a roll of bitumen roofing membrane that is partially or fully formed of recycled materials, e) paper wrapping used to partially or fully wrap a roof of bitumen roofing membrane that is partially or fully formed of recycled materials, f) paper or cardboard box that is partially or fully formed of recycled materials, and/or g) a cover bag that is placed over a roll of bitumen roofing membrane that is partially or fully formed of recycled material.

33. The bitumen roofing membrane as defined in claim 23, wherein said granules constitutes 0.1-60 wt. % of said bitumen roofing membrane.

34. The bitumen roofing membrane as defined in claim 32, wherein said granules constitutes 0.1-60 wt. % of said bitumen roofing membrane.
